(19) United States
(12) Patent Application Publication
(10) Pub. No.: US 2006/0087089 A1
(43) Pub. Date: Apr. 27, 2006

(54) Snowboard binding

(76) Inventors: Yasutomi Okano, Kani-gun (JP); Toru Tanaka, Mino-City (JP); Shigehiro Kawai, Tajimi-City (JP)

Correspondence Address: Jeffrey J. King;BLACK LOWE & GRAHAM PLLC, Suite 4800, 701 Fifth Avenue, Seattle, WA, 98104, US

(21) Appl. No.: 11/258,734

(22) Filed: Oct. 25, 2005

Related U.S. Application Data
(63) Continuation-in-part of application No. PCT/EP04/50585, filed on Apr. 22, 2004.

(30) Foreign Application Priority Data
Apr. 25, 2003 (DE) 10319056.2

(51) Int. Cl. B62B 13/00; B62B 17/00

(52) U.S. Cl. 280/14.22

(57) ABSTRACT

The invention relates to a snowboard binding, in particular adapted to flexible boots. According to said invention, a heel clams is arranged on a soleplate which is disposed under abase plate, is longitudinally displaceable and fixable directly to the snowboard base plate by friction connection or form closure. A calf support is vertically adjustable on the heel bracket and supported in such a way that enables it to move laterally.

### CLAIM OF PRIORITY

This is a continuation-in-part application which claims priority from PCT/EP2004/050585, published in German, filed Apr. 22, 2004, based on German patent Application No. 10319056.2 filed Apr. 25, 2003 which are incorporated herein by reference.

### TECHNICAL FIELD

This invention relates to a snowboard binding particularly suited for soft and flexible shoes or soft shoes with
a standing surface on a base plate for binding the shoe that can be securely attached to the snowboard;
a heel clamp adjustable to different shoe sizes that encloses the heel of the shoe and to which a calf support can be attached, and
belt or clamp-like front and back fixation elements that cross the show and attach to the base plate and/or the heel clamp.

### BACKGROUND

Such a snowboard binding has been described in DE 297 00 631 01. In the there described snowboard binding the base plate is fixed using a circular tension plate, which can be set into a circular opening in the base plate and at the upper edge of which a flange covers the periphery of the circular opening. When the tension plate is securely attached to the snowboard with screws or in a similar way, the base plate will be tightened between the upper side of the snowboard and the flange like edge of the tension plate. Moreover, the edge of the circular opening in the base plate is formed with a serration that engages with a similar serration at the flange-like edge of the tension plate, so that the base plate can be fixed at the snowboard with the tension plate either in form of an interlocking mechanism or else a loaded spring. Loosening the mounting of the tension plate at the snowboard, so that the tension plate is given a certain play, the serrations can be disengaged, so that the base plate can rotate relative to the tension plate and subsequently fixed again with the tension plate in a different position on the snowboard.

The heel clamp has side plates surrounding the shoe, that are equipped with an angular end portion that is passed adjustably through the corresponding slit openings on the base plate and can be fixed with pins or similar means in different positions. This allows adjusting the central section of the heel clamp passing behind the heel to different distances from the center of the tension plate. Regardless of the size of the shoe set into the binding this permits to achieve a predetermined position of the shinbone axis relative to the base plate or the tension plate.

At the heel clamp a calf support may be attached in different vertical positions. If necessary, the calf support may also be adjusted in lateral direction by attaching the sides of the calf support held up by the heel clamp in different positions on the base plate. That means one side will be attached further back on the base plate than the other.

Belts to mount the shoe in the binding or similar contraptions may be attached at boreholes that are located on the lateral vertical ribs on the base plate or the heel clamp.

The purpose of the invention is to provide a snowboard binding characterized by a similar or even greater variability a high load bearing capacity at low production costs.

This goal has been achieved according to this invention in that the heel clamp is attached to a base plate arranged under a sole plate that in turn is adjustable relative to the base plate in longitudinal direction and mounted indirectly on the base plate either by a loaded spring or an interlocking mechanism.

The invention is based on the general concept of forming the contact surface for the shoe within the binding size variable and to provide for this purpose a base plate attached to a sole plate.

This permits to take into consideration on the one hand, that people with small feet usually are also of smaller stature than people with large feet, so that they would like to use smaller snowboards that provide only space for small contact areas.

At the same the construction according to this invention has the advantage that the heel clamp with its associated sole plate may be formed or connected as a single piece, or else be substantially stiffened by the sole plate. Accordingly, the heel clamp is highly resilient, but nevertheless allows to be adjusted to any shoe size through different mounting of the sole plate relative to the base plate in its position on the snowboard.

According to one of the preferred embodiments for which an independent claim has been filed, the invention provides that the calf support in its predetermined or mounting position on the base and sole plates forms with the two sides and in conjunction with the calf support a U-shaped profile, extending into two slits between the inside of the side portions of the heel clamp and the long edges or the long side walls of the base plate and engages there with two projections formed roughly parallel to the edges of the side portions of the heel clamp or the long edges of the base plate. These projections may in particular be formed as bolts that engage fit into oblong slit opening in the side portions of the heel clamp.

Otherwise the calf support according to one preferred embodiment, for which an independent claim has been filed, may be supported in a vertically adjustable manner and movable in lateral direction by the central portion of the heel clamp.

Based on the lateral mobility the calf support is able to follow the movements of the legs. Here the sides of the calf support move in mutually opposite directions in the corresponding slits between the side portions of the heel clamp and the long edges or the long side walls of the base plate. If the calf support is adjusted in vertical direction, the inclination of the calf support changes, so that the legs are supported in the desired forward, or eventually also backward lean position.

This construction has the advantage that the calf support is supported by parts of comparatively high weight bearing capacity. Otherwise the desired adjustments can be made directly at the calf support. In contrast to the above described prior art is for the adjustment of the calf support an adjustment of the heel clamp neither required nor possible. The overall effect results in an obvious and easily comprehensible function.

According to one particularly practical preferred embodiment, for which an independent claim has been filed, the belt or clamp for the forefoot portion of the shoe is attached with a loop to the underside of the base plate, passing through a slit in the base plate that runs roughly parallel to the long axis of the base plate and either is or can be tied to the belt or clamp. Here the loop ends can be inserted into different recesses formed in the slit on the shoe side, so that the belt or clamp may be hooked to the base plate more to the front or back in longitudinal direction of the shoe.

The slit is formed preferably on the shoe-side of one of the vertical ribs of the base plate. This has the advantage that the belt or clamp can also fit tightly to the side of the shoe. Otherwise is the anchorage of the belt or clamp located in a well protected position.

For the attachment of a the tensioned area of the shoe covering belt or clamp the side portions of the heel clamp may be equipped with flexible loops, that assume under the tension of the belt or clamp a V-shape opening toward the side portions of the heel clamp. Since the belt of clamp can be adjustably be positioned in these loops or else hooked into various positions, this changes the side ratio of the V-legs, which in turn results in a displacement of the anchoring point of the belt or clamp in the direction of the long axis of the shoe.

This permits an easily comprehensible displacement of the belt or clamp relative to the shoe.

Regarding other preferred characteristics of the invention refer to the claims as well as the following explanation of the drawings, serving to describe particularly preferred embodiments of the invention. Naturally, patent rights are claimed not only for the explicitly described or shown feature combinations, but generally any possible combination of the given characteristics.

The drawings show:

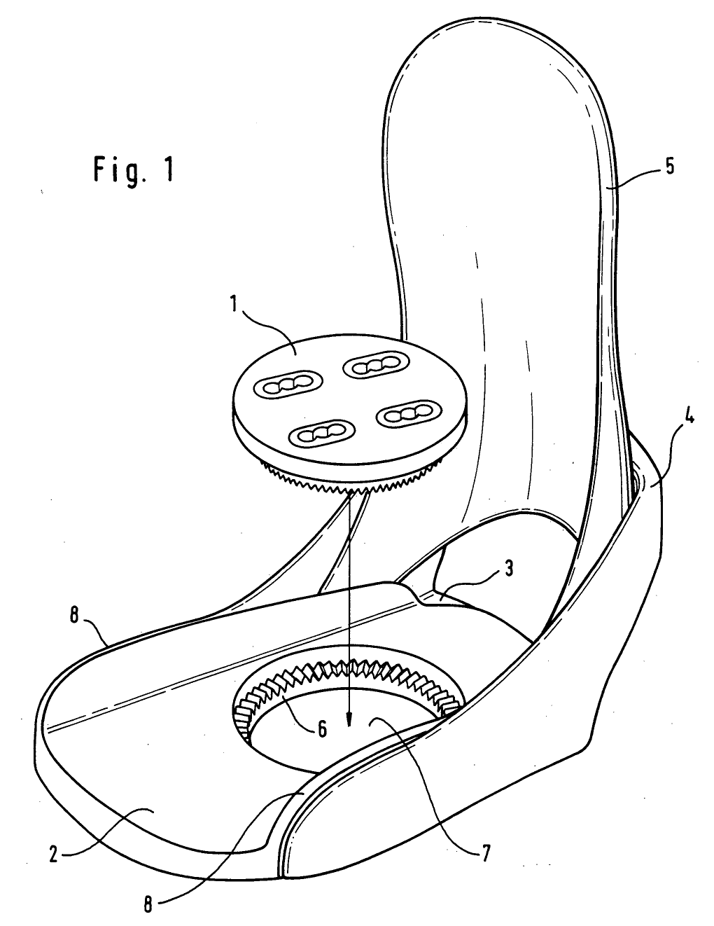

FIG. 1 Perspective view of the snowboard binding according to this invention. Belts or clamps running over the not shown shoe have been omitted;

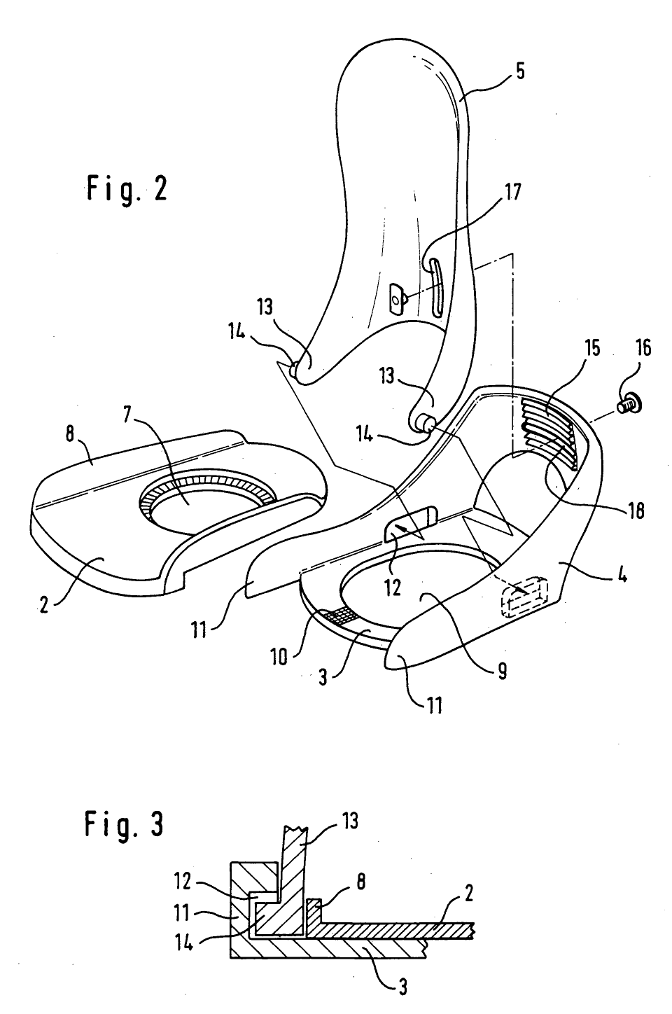

FIG. 2 Exploded view of this binding;

FIG. 3 Vertical cross-section through a side portion of the heel clamp as well as a side of the calf support;

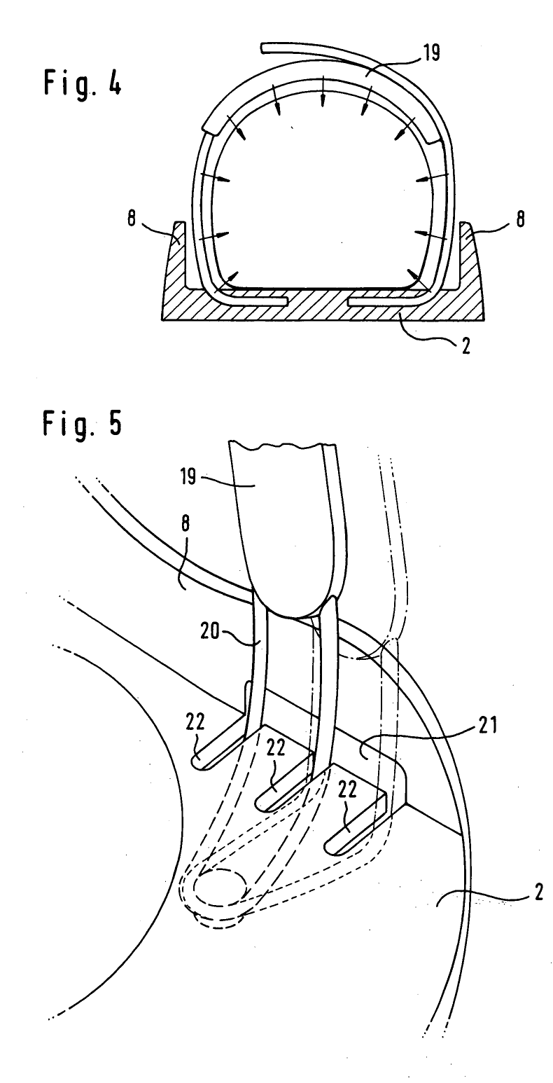

FIG. 4 cross-section through the base plate in the area of the belt crossing the forefoot;

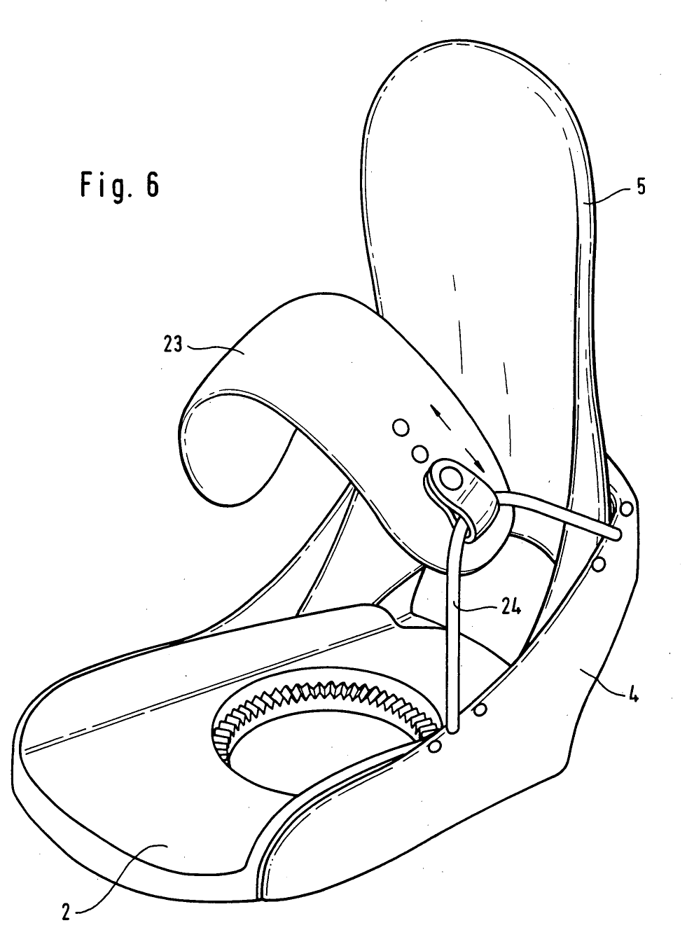

FIG. 5 perspective view of the anchorage of the belt at the base plate;

FIG. 6 attachment of a tension section of a the shoe holding belt at the side portion of the heel clamp; and

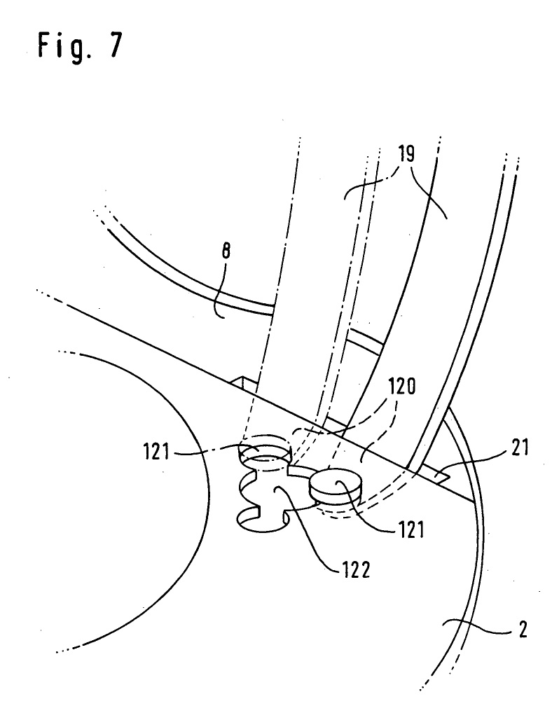

FIG. 7 a modified anchorage of the belt designed for the forefoot to the base plate as compared to the one shown in FIG. 5.

According to FIGS. 1 and 2 the snowboard binding of the present invention comprises basically a circular tension plate 1, a base plate 2, a sole plate 3 with integratedly formed heel clamp 4 and a calf support 5.

The tension plate 1 can be attached with not shown screws that are screwed into threaded portions on the side of the snowboard, to a not shown snowboard. In order to permit mounting in different positions relative to the said threaded portions on the side of the snowboard, the tension plate 1 is formed with a pattern of holes that consists in this embodiment of four rows of holes with oblong, mutually merging holes.

The flange-like edge of the tension plate 1 has on its underside a serration that engages in mounted condition of the binding with a corresponding upper serration in the flange-like edge 6 in a circular opening 7 formed in the base plate 2. Here a vertical edge region of the circular opening 7 encloses a corresponding vertical edge region of the tension plate 1 with essentially zero backlash.

When the attachment screws are loosened sufficiently to allow for a corresponding vertical play of the tension plate 1 relative to the snowboard, the serration on the tension plate 1 can be lifted out of the serration formed in edge 6 of the circular opening 7 in the base plate 2, so that the base plate 2 can be brought in essentially any rotational position, which then can be fixed by tensioning the tension plate 1 on the snowboard, i.e., through screwing in of the attachment screws into the threaded portions in the snowboard.

The upper side of the base plate 2 forms a contact surface for a shoe (not shown). On its long sides the contact surface is limited by vertical ridges 8.

The sole plate 3 can be positioned under the base plate 2 and is mounted directly via base plate 2 on the snowboard either with a loaded spring or through positive fitting. For this purpose a circular ridge formed at the underside of the base plate 2 at the circular opening 7 projects into an oval opening 9, the shorter diameter of which corresponds to the outer diameter of the ring ridge and the longer diameter is larger than the outer diameter of the ring ridge. In the direction of the longer diameter there are in front of and behind the oval opening 9 on the upper side of the sole plate 3 a honeycomb profile 10 with several sequentially arranged transverse grooves. This honeycomb profile engages in the mounted condition of the binding with a similar honeycomb profile formed on the underside of the base plate in longitudinal direction of the base plate 2 in front of and behind the circular opening 7. In this way is the sole plate 3 fixed in longitudinal direction on base plate 2 by the mutually engaging honeycomb profiles. The honeycomb profiles have in addition to this the effect that the ring ridge at the circular opening 7 on the underside of the base plate 2 engages in the oval opening 9 of the sole plate 3, so that the base plate 2 is secured in positive fitting relative to the sole plate 3 also in transverse direction. The sole plate 3 will in addition also be fixed through positive fitting relative to the base plate 2, when the tension plate 1 is pressed against the upper side of the snowboard.

The heel clamp 4 is formed as an integral part of the sole plate 3, where the side portions of the heel clamp 4 merge with the cheeks 11 of the sole plate 3. These cheeks 11 are formed and arranged in such a manner, that between the inside of the cheeks 11 and the outside of the ridges 8 of the sole plate 3 at least within the rear half of the ridges 8 slits remain open. In the area of these slits oblong recesses 12 are formed in the side portions of the heel clamp 4.

The calf support 5 has according to FIGS. 2 and 3 lower shanks 13 that form with the calf support 5 a U-shaped profile. The shanks 13 have on the outside of their tips pins 14. These fit in the mounted condition of the binding into oblong recesses 12, where a slipping of these pins 14 out of the oblong recesses 12 is prevented in that the ends of the shanks 13 are held fixed in the slits between the ridges 8 of the base plate 2 and the shanks of the calf support 5 in the direction of the pins 14.

On the outside of the calf support 5 in the are of the center portion of the heel clamp 4 horizontal ridges are formed, which according to FIG. 2 fit into horizontal grooves between the corresponding horizontal ridges 15 on the center portion of the heel clamp 4 facing the calf support 5. The ridges formed on the calf support 5 are held in contact by a clamping screw arrangement 16 that passes through a vertical slit 17 in the calf support 5 as well as a horizontal slit 18 in the heel clamp 4 with the grooves between the ridges 15 of the heel clamp 4. The clamping screw arrangement 16 is preferably formed in such a way that in the tightened condition ridges formed on the calf support 5 are only held in contact with the grooves between the ridges 15 of the heel clamp 4 without resulting in any significant positive fitting between the ridges and grooves. This ensures that the calf support 5 remains movable in lateral direction relative to the heel clamp 4 and thus renders it able to follow the relevant lateral movements of the calf, because the pins 14 on the ends of the shanks 13 in the calf support 5 are arranged adjustably in horizontal direction in the recesses 12.

When the clamping screw arrangement 16 is loosened, the ridges of the calf support 5 can be lifted out of the grooves between the ridges 15 in the heel clamp 4 in order to vertically adjust the calf support 5 on the heel clamp 4, changing the inclination of the calf support 5. Through repeated tensioning of the clamping screw arrangement 16 the calf support 5 can be fixed in the new position, i.e., with a different inclination, while mobility of the calf support 5 in lateral direction remains possible.

That means that the invention permits adjustment of the inclination of a calf support 5 that remains mobile in lateral direction.

An appropriate structure of the clamping screw arrangement can also enable a lateral mobility of the positive fitting between heel clamp and calf support 5.

The parts of a belt 19 fitting around the frontal portion of the shoe can be according to FIG. 5 fixed or attached with the loop 20 on the underside of the base plate 2. The strands of loop 20 pass through a slit 21 from the underside of the base plate 2 to its topside and thereby to the portions of belt 19. Several transverse recesses 22 are formed in slit 21 into which the strands of loop 20 can be fitted. The result is that the strands of loop 20 can be adjusted at any time in longitudinal direction of the snowboard binding without the necessity of detaching the loop 20 from its anchorage on the underside of the base plate 2, or else moved forward, so that the tension of belt 19 acts with correspondingly changed direction and on the shoe or the foot.

In the modified embodiment shown in FIG. 7 the belt 19 extends into an end section 120 with a molded tip 121 that can be hooked as positive fitting for example into three correspondingly formed recesses in an opening 122 in the base plate 2 and thus be anchored there. On the one hand this permits to change the effective length of the belt 19. On the other hand this allows extending the end section 120 with the belt 19 in longitudinal direction of the snowboard binding.

Since the belt 19 and its loops 20 or its end section 120 run above the base plate 2 on the inside of the side ridges 8 of the base plate 2, the belt 19 can also fit tightly to the shoe sides, as indicated by the arrows in FIG. 4.

For the attachment of a tensioning section of a the shoe crossing belt 23 according to FIG. 6 at the side portions of the heel clamp 4 loops 24 are arranged to which the portions of the belt 23 are tied. Depending on the sliding position these loops 24 do have during tensioning of the belt 23 differently long V-shaped legs. This is synonymous with the belt the portions of belt 23 being able to assume different horizontal and vertical positions and that the direction of the pressure of the belt 23 acting on the shoe or foot can be modified accordingly.

The belt 19 and/or 23 can be replaced by clamp-like parts.

We claim:

1. Snowboard binding, particularly suited for soft and flexible shoes or soft shoes with:
(a) a base plate (2) providing a contact area for the shoe to be bound that can be securely attached to a snowboard,
(b) a heel clamp (4) adjustable to different shoe sizes that encloses the heel of the shoe and to which a calf support (5) can be attached, and
(c) belt or clamp-like front and back fixation elements (19, 23) that cross the shoe and attach to the base plate (2) and/or the heel clamp (4) characterized in that, the heel clamp (4) is formed at a sole plate (3) located below the base plate (2) and that is adjustable relative to the base plate in its longitudinal direction and indirectly through the base plate either by a loaded spring or through a positive fitting.

2. Snowboard binding according to claim 1, characterized in that the base plate (2) engages through an edge formed on its underside with an oval or oblong slit opening (9) in the sole plate (3), where the longer diameter is larger than the outer diameter of the ring ridge and the transverse dimension corresponds to the outer diameter of the circular ridge.

3. Snowboard binding according to claim 1 or 2, characterized in that on the underside of the base plate (2) a honeycomb profile is formed by ridges, which engages with a similar honeycomb profile (10) formed on the upper side of the sole plate (3) in such a way, that the mutual engagement of the honeycomb profiles secures the sole plate (3) relative to the base plate (2) through form-fitting in either transverse or longitudinal direction.

4. Snowboard binding, particularly suited for soft and flexible shoes or soft shoes with:
(a) a base plate (2) providing a contact area for the shoe to be bound that can be securely attached to a snowboard,
(b) a heel clamp (4) adjustable to different shoe sizes that encloses the heel of the shoe and to which a calf support (5) can be attached, and
(c) belt or clamp-like front and back fixation elements (19, 23) that cross the shoe and attach to the base plate (2) and/or the heel clamp (4) in particular according to one of the claims 1 through 3 characterized in that, a vertically supported or supportable calf support (5) formed at the heel clamp (4) in its predetermined or mounting position forms with the base and sole plates (2, 3) and two shanks (13) in conjunction with the calf support (5) a U-shaped profile, extending into two slits between the inside of the side portions of the heel clamp (4) and the long edges or the long side walls (8) of the base plate (2) and engages with two projections (14) and with edges that are approximately parallel to the edges of the base plate and the side portions of the heel clamp or the base plate.

5. Snowboard binding according to claim 4, characterized in that the calf support (5) is supported at the heel side central portion of the heel clamp (4) so that it is adjustable in vertical and/or lateral direction or else movable.

6. Snowboard binding according to claim 4 or 5, characterized in that on the side of the calf support (5) facing the central portion of the heel clamp (4) horizontal ridges (15) are formed that engage with similar ridges on the outside of the calf support (5).

7. Snowboard binding, particularly suited for soft and flexible shoes or soft shoes with:
(a) a base plate (2) providing a contact area for the shoe to be bound that can be securely attached to a snowboard,
(b) a heel clamp (4) adjustable to different shoe sizes that encloses the heel of the shoe and to which a calf support (5) can be attached, and
(c) belt or clamp-like front and back fixation elements (19, 23) that cross the shoe and attach to the base plate (2) and/or the heel clamp (4) in particular according to one of the claims 1 through 6, characterized in that the belt or clamp (19) for the forefoot on the underside of the base plate (2) is anchored or can be anchored with an end section (20, 120) that passes through a slit (21) in the base plate that is oriented parallel to the long axis of the base plate.

8. Snowboard binding according to claim 7, characterized in that the end section is formed as a loop (20) and the loop strands can be fitted into different recesses (22) formed in the slit edge on the shoe side, so that the belt or clamp (19) can be attached more to front or back in longitudinal direction of the snowboard.

9. Snowboard binding according to claim 7 or 8, characterized in that the end section (20, 120) can be anchored in several positions on the underside of the base plate, so that the length of the belt or clamp (19) or the position of the end section (120) can be adjusted in longitudinal direction of the snowboard.

10. Snowboard binding according to one of the claims 7 through 9, characterized in that the end section (120) is provided with a molded tip (121) that can be hooked as positive fitting into several recesses or areas in an opening (122) in the base plate (2).

11. Snowboard binding, particularly suited for soft and flexible shoes or soft shoes with:
(a) a base plate (2) providing a contact area for the shoe to be bound that can be securely attached to a snowboard,
(b) a heel clamp (4) adjustable to different shoe sizes that encloses the heel of the shoe and to which a calf support (5) can be attached, and
(c) belt or clamp-like front and back fixation elements (19, 23) that cross the shoe and attach to the base plate (2) and/or the heel clamp (4) in particular according to one of the claims 1 through 10, characterized in that for the attachment of a tensioning section of a the shoe crossing belt (23) flexible loops (24) are provided at the side portions of the heel clamp (4), that assume under the tension of the belt or clamp a V-shape opening toward the side portions of the heel clamp and that the belt or clamp is adjustably attached and/or can be hooked into different position on the loops.

12. Snowboard binding according to claim 11, characterized in that the loops (24) can be hooked into different positions on the heel clamp (4).
